(19) United States
(12) Patent Application Publication
(10) Pub. No.: US 2013/0069557 A1
(43) Pub. Date: Mar. 21, 2013

(54) LED Lighting Circuit and LED Luminaire

(71) Applicants: Hideo KOZUKA, Yokosuka-shi (JP); Tatsuya KONISHI, Yokosuka-shi (JP); Hiroshi TERASAKA, Yokosuka-shi (JP)

(72) Inventors: Hideo KOZUKA, Yokosuka-shi (JP); Tatsuya KONISHI, Yokosuka-shi (JP); Hiroshi TERASAKA, Yokosuka-shi (JP)

(73) Assignee: Toshiba Lighting & Technology Corporation, Yokosuka-shi (JP)

(21) Appl. No.: 13/597,715

(22) Filed: Aug. 29, 2012

(30) Foreign Application Priority Data
Sep. 20, 2011 (JP) 2011-204853

(51) Int. Cl. H05B 37/00

(52) U.S. Cl. 315/232

(57) ABSTRACT

According to one embodiment, an LED lighting circuit includes a lighting circuit provided between an external power supply and LED elements and a control circuit that controls the lighting circuit. The lighting circuit includes an electrolytic capacitor, the capacitance of which decreases to be lower than a rated value or the impedance of which increases to be higher than a rated value at temperature equal to or lower than −20° C. The control circuit performs an initial lighting operation under a temperature environment equal to or lower than −20° C.

### INCORPORATION BY REFERENCE

The present invention claims priority under 35 U.S.C. §119 to Japanese Patent Application No. 2011-204853 filed on Sep. 20, 2011. The content of the application is incorporated herein by reference in their entirety.

### FIELD

Embodiments described herein relate generally to an LED lighting circuit that lights LED elements and an LED luminaire including the LED lighting circuit.

### BACKGROUND

In general, in a lighting circuit of a luminaire used under a low-temperature environment, in order to solve a deficiency that occurs under the low-temperature environment, a component such as an electronic component is replaced with a component adapted to the low-temperature environment or a special component is added.

For example, in an LED lighting circuit that lights LED elements, an electrolytic capacitor is used in a lighting circuit. The electrolytic capacitor has a characteristic that, when the electrolytic capacitor is left untouched in a light-off (non-energized) state under a low-temperature environment equal to or lower than −20° C., the capacitance of the electrolytic capacitor decreases to be lower than a rated value or the impedance of the electrolytic capacitor increases to be higher than a rated value because the temperature of the electrolytic capacitor drops to temperature equal to or lower than −20° C.

In a state in which the capacitance of the electrolytic capacitor decreases to be lower than the rated value or the impedance of the electrolytic capacitor increases to be higher than the rated value in this way, when the LED lighting circuit performs a lighting operation at a rated output, smoothing by the electrolytic capacitor is not sufficiently performed. Therefore, a deficiency occurs in which an unstable operation due to the insufficient smoothing occurs, a protecting circuit that detects the occurrence of the unstable operation stops the lighting operation, and the LED elements are not lit.

Without the change to the component adapted to the low-temperature environment or the addition of the component as explained above, the deficiency that occurs under the low-temperature environment may not be able to be solved.

Therefore, it is an object of the present invention to provide an LED lighting circuit that can surely light LED elements under a low-temperature environment equal to or lower than −20° C. without changing or adding a component and an LED luminaire including the LED lighting circuit.

### BRIEF DESCRIPTION OF THE DRAWINGS

FIG. 1 is a circuit diagram of an LED lighting circuit according to an embodiment;

FIG. 2 is a perspective view of an LED luminaire including the LED lighting circuit; and

FIG. 3 is a graph of changes in the capacitance and the impedance with respect to the temperature of an electrolytic capacitor used in the LED lighting circuit;

FIG. 4 is a waveform chart of a power supply voltage output from the electrolytic capacitor when the capacitance of the electrolytic capacitor decreases or the impedance of the electrolytic capacitor increases; and

FIG. 5 is a graph of a relation between the capacitance of the electrolytic capacitor and a dimming output ratio.

### DETAILED DESCRIPTION

An LED lighting circuit according to an embodiment includes a lighting circuit provided between an external power supply and LED elements and a control circuit that controls the lighting circuit. The lighting circuit includes an electrolytic capacitor, the capacitance of which decreases to be lower than a rated value or the impedance of which increases to be higher than a rated value at temperature equal to or lower than −20° C. The control circuit performs an initial lighting operation under a temperature environment equal to or lower than −20° C.

With this configuration, even if the capacitance of the electrolytic capacitor decreases to be lower than the rated value or the impedance of the electrolytic capacitor increases to be higher than the rated value under a low-temperature environment equal to or lower than −20° C., it can be expected that the LED elements can be surely lit by performing the initial lighting operation without changing or adding a component.

An embodiment is explained below with reference to the accompanying drawings.

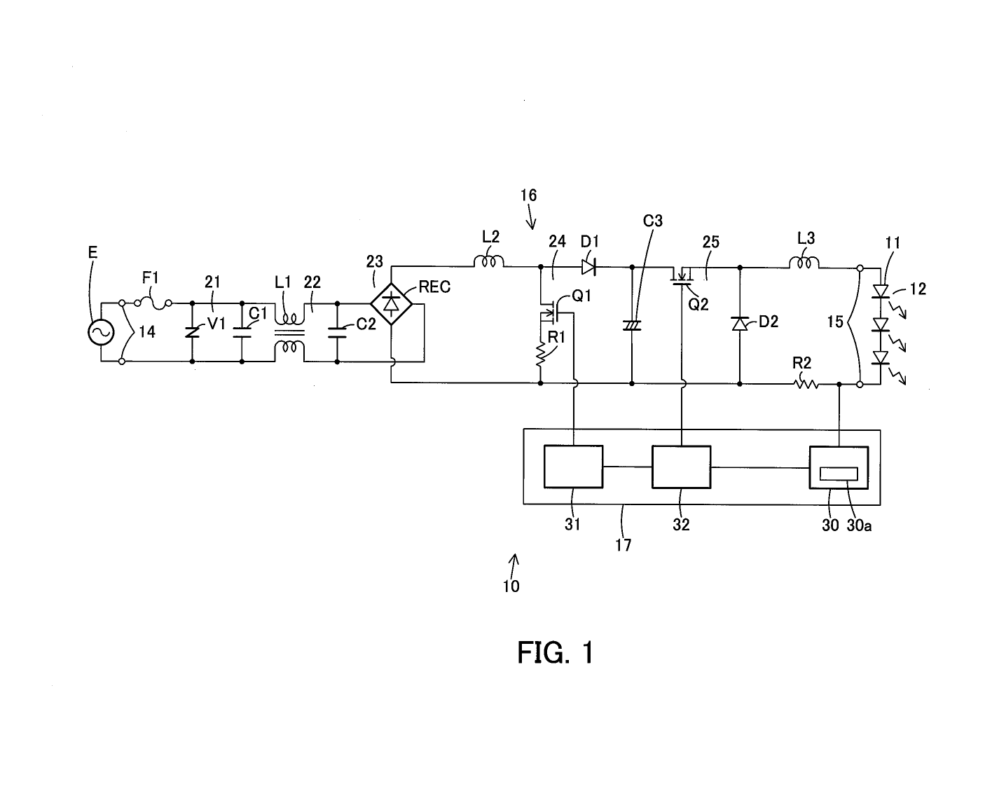

In FIG. 1, an LED (Light-Emitting Diode) lighting circuit 10 is connected to an alternating-current power supply E, which is the external power supply. The LED lighting circuit 10 is configured to supply electric power to an LED module 12 including plural LED elements 11 and light the plural LED elements 11. Further, the LED lighting circuit 10 is configured as a voltage-free type adapted to the alternating-current power supply E in a range of 100 V to 242 V that varies depending on a setting environment or the like.

The LED lighting circuit 10 includes a lighting circuit provided between input sections 14 connected to the alternating-current power supply E and output sections 15 to which the plural LED elements 11 are connected and a control circuit 17 that controls the lighting circuit 16.

The lighting circuit 16 includes a surge absorbing circuit 21 and a filter circuit 22 sequentially connected to the input section 14 via a fuse F1, a rectifying circuit 23 connected to an output side of the filter circuit 22, an AC-DC converter 24 connected to an output side of the rectifying circuit 23, and a DC-DC converter 25 connected to an output side of the AC-DC converter 24.

The surge absorbing circuit 21 includes a varistor V1 connected to the input section 14 in parallel via the fuse F1.

The filter circuit 22 includes a capacitor C1, an inductor L1, and a capacitor C2 connected to the varistor V1 in parallel and reduces noise superimposed on a power supply voltage.

A full-wave rectifier REC is used for the rectifying circuit 23. An input end of the full-wave rectifier REC is connected to an output end of the filter circuit 22. An input end of the AC-DC converter 24 is connected to an output end of the full-wave rectifier REC in parallel.

The AC-DC converter 24 includes a rising-voltage chopper circuit. The AC-DC converter 24 chops an output voltage of the rectifying circuit 23 and outputs a predetermined direct-current voltage according to an ON and OFF operation of a field effect transistor Q1 functioning as a switching element. The AC-DC converter 24 outputs, for example, DC 420 V.

The AC-DC converter 24 includes a series circuit of an inductor L2, the field effect transistor Q1, and a resistor R1 connected between the output ends of the full-wave rectifier REC and a series circuit of a diode D1 for backward flow prevention and an electrolytic capacitor C3 for smoothing connected to the field effect transistor Q1 and the resistor R1 in parallel. The field effect transistor Q1 performs the ON and OFF operation at a predetermined switching frequency and predetermined ON duty according to the control by the control circuit 17, whereby a predetermined direct-current voltage is generated between both ends of the electrolytic capacitor C3. In this way, the AC-DC converter 24 is configured to boost and convert an alternating-current voltage of 100 V to 242 V into a direct-current voltage of, for example, 420 V and output the direct-current voltage to the DC-DC converter 25.

In the electrolytic capacitor C3, an anode foil and a cathode foil wound via a separator are housed in a container and an electrolyte is encapsulated in the container.

The DC-DC converter 25 includes a voltage-falling chopper circuit. The DC-DC converter 25 includes a series circuit of a field effect transistor Q2 and a diode D2 functioning as switching elements connected to both ends of the electrolytic capacitor C3 of the AC-DC converter 24. An inductor L3 is connected between a cathode of the diode D2 and one output section 15. A resistor R2 is connected between an anode of the diode D2 and the other output section 15. The field effect transistor Q2 performs an ON and OFF operation at a predetermined switching frequency and predetermined ON duty according to the control by the control circuit 17, whereby a predetermined direct-current voltage for lighting the LED elements 11 is generated between both ends of the output sections 15.

The control circuit 17 includes a detecting section 30 that detects an output current of the DC-DC converter 25, an AC-DC control section 31 that controls the field effect transistor Q1 of the AC-DC converter 24, and a DC-DC control section 32 that controls the field effect transistor Q2 of the DC-DC converter 25. For example, the control circuit 17 includes an IC integrally including these sections.

The detecting section 30 is connected to an output side of the DC-DC converter 25. The detecting section 30 includes an output-current detecting circuit that detects the output current of the DC-DC converter 25 and an output-voltage detecting circuit that detects an output voltage of the DC-DC converter 25. The detecting section 30 outputs detection signals of these circuits to the DC-DC control section 32. Further, the detecting section 30 includes a protecting circuit 30a that determines abnormality on the basis of the detected output current and the detected output voltage. When it is determined that abnormality occurs, the detecting section 30 outputs an abnormality detection signal to the AC-DC converter 24 and the DC-DC converter 25.

The AC-DC control section 31 performs a lighting operation for the field effect transistor Q1 according to an ON and OFF operation. The AC-DC control section 31 controls the switching frequency and the ON duty of the field effect transistor Q1 according to the lighting operation. The AC-DC control section 31 has a function of stopping the oscillation of the field effect transistor Q1 according to a protecting circuit operation (a protection operation) by an input of the abnormality detection signal from the protecting circuit 30a.

The DC-DC control section 32 performs a lighting operation for the field effect transistor Q2 according to PWM control. The DC-DC control section 32 controls the switching frequency and the ON duty of the field effect transistor Q2. The DC-DC control section 32 has a function of stopping the oscillation of the field effect transistor Q2 according to a protecting circuit operation by an input of the abnormality detection signal from the protecting circuit 30a.

The control circuit 17 controls the lighting circuit 16 and has a function of performing an initial lighting operation under a temperature environment equal to or lower than −20° C. Examples of the initial lighting operation include fade-in lighting, repetition of a predetermined number of times of resetting of the protecting circuit operation and the lighting operation, and disabling of the protecting circuit operation and enabling of the protecting circuit operation after the elapse of a predetermined time from the start of energization.

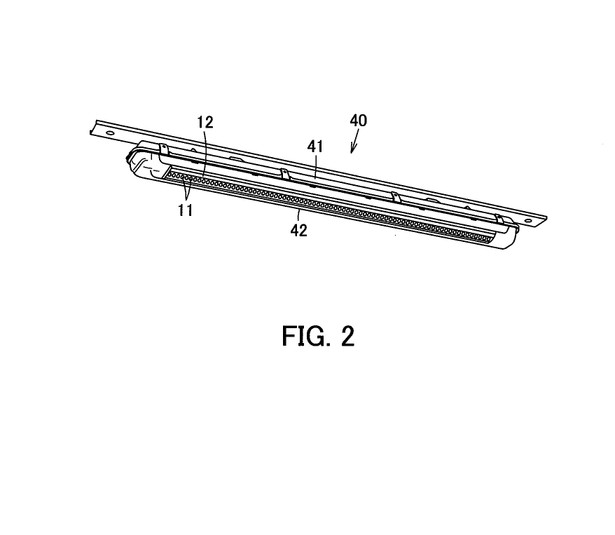

In FIG. 2, an LED luminaire 40 including the LED lighting circuit 10 is shown. The LED luminaire 40 is a luminaire for low temperature. The LED luminaire 40 includes a luminaire body 41, the LED lighting circuit 10 and the LED module 12 attached to the luminaire body 41, and a translucent cover 42 that is attached to the luminaire body 41 to cover the LED module 12. The LED luminaire 40 is used while being set in a low-temperature environment of, for example, −35° C. to −40° C. in a freezing warehouse or the like.

The operation of the LED lighting circuit 10 is explained.

When the alternating-current power supply E is turned on, the LED lighting circuit 10 outputs a power supply voltage, which is rectified by the rectifying circuit 23 through the fuse F1, the surge absorbing circuit 21, and the filter circuit 22, to the AC-DC converter 24.

The AC-DC converter 24 chops an output voltage of the rectifying circuit 23 and boosts the output voltage to a direct-current voltage of, for example, 420 V according to the ON and OFF operation of the field effect transistor Q1 by the control by the AC-DC control section 31 and outputs the direct-current voltage to the DC-DC converter 25.

The DC-DC converter 25 chops an output voltage of the AC-DC converter 24 and drops the output voltage to a direct-current voltage for lighting the LED elements 11 according to the ON and OFF operation of the field effect transistor Q2 by the control by the DC-DC control section 32 and outputs the direct-current voltage to the LED elements 11. Consequently, the LED elements 11 are lit.

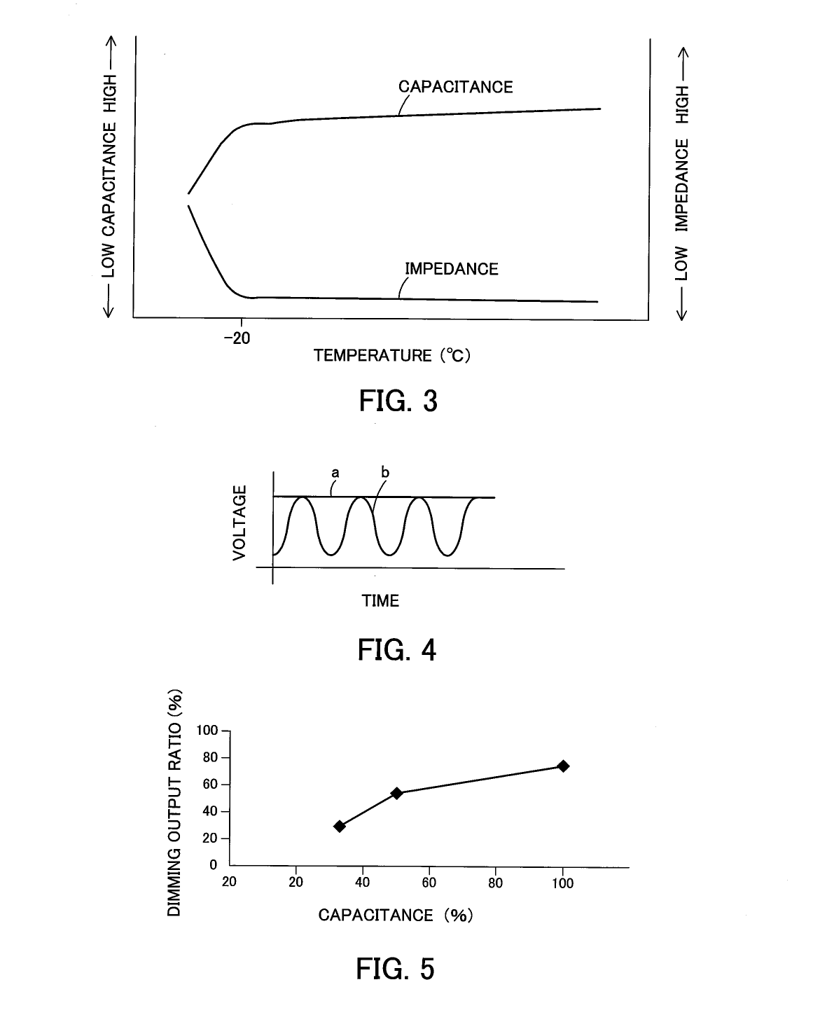

The electrolytic capacitor C3 used in the LED lighting circuit 10 is a general-purpose component generally used in various fields. As shown in FIG. 3, the electrolytic capacitor C3 has a characteristic that the capacitance of the electrolytic capacitor C3 decreases to be lower than a rated value and the impedance of the electrolytic capacitor C3 increases to be higher than a rated value according to freezing of an electrolyte under a low-temperature environment equal to or lower than −20° C. Even under the low-temperature environment equal to or lower than −20° C., the temperature of the electrolytic capacitor C3 rises according to energization and the capacitance and the impedance of the electrolytic capacitor C3 are restored to the rated values.

As indicated by a waveform “a” in FIG. 4, when the capacitance and the impedance of the electrolytic capacitor C3 are the rated values, an output of the AC-DC converter 24 is converted into a direct-current voltage smoothed to, for example, 420 V by the electrolytic capacitor C3.

However, if the LED lighting circuit 10 is left untouched in a light-off (non-energized) state under the low-temperature environment equal to or lower than −20° C., the alternating-current power supply E is turned on in a state in which the temperature of the electrolytic capacitor C3 drops to temperature equal to or lower than −20° C. and the capacitance of the electrolytic capacitor C3 decreases to be lower than the rated value or the impedance of the electrolytic capacitor C3 increases to be higher than the rated value, and the LED lighting circuit 10 performs the lighting operation at a rated output, a deficiency occurs in which an output of the AC-DC converter 24 is not normally smoothed by the electrolytic capacitor C3. As indicated by a waveform “b” in FIG. 4, the output of the AC-DC converter 24 has a rippled waveform in which the output is not normally smoothed by the electrolytic capacitor C3 and the power supply voltage substantially drops.

When the power supply voltage input from the AC-DC converter 24 drops, the DC-DC converter 25 performs control to raise the power supply voltage. However, if the DC-DC converter 25 performs the control at timing when the power supply voltage input from the AC-DC converter 24 rises, overshoot occurs and an over current is output from the DC-DC converter 25.

When the detecting section 30 detects the over current, the abnormality detection signal from the protecting circuit 30a is output to the AC-DC control section 31 and the DC-DC control section 32. The lighting circuit 16 is forcibly stopped by the protecting circuit operations in the control sections 31 and 32.

Therefore, even if the alternating-current power supply E is turned on in a state in which the temperature of the electrolytic capacitor C3 drops to the temperature equal to or lower than −20° C. and the capacitance of the electrolytic capacitor C3 decreases to be lower than the rated value or the impedance of the electrolytic capacitor C3 increases to be higher than the rated value, a deficiency occurs in which the LED elements 11 are prevented by the protecting circuit operation from being lit.

Therefore, the control circuit 17 in this embodiment performs the initial lighting operation during the start of energization to enable the LED elements 11 to be surely lit.

Examples of the initial lighting operation include fade-in lighting. In the fade-in lighting, during the start of energization, the DC-DC control section 32 performs dimming start control for raising the ON duty of the PWM control of the field effect transistor Q2 continuously or stepwise from, for example, 0%.

Consequently, an output of the DC-DC converter 25 starts from a low output lower than a rated output. A discharge amount of electric power from the electrolytic capacitor C3 of the AC-DC converter 24 decreases. Therefore, in an output from the AC-DC converter 24, the power supply voltage does not substantially drop unlike the waveform “b” in FIG. 4. A smoothed direct-current voltage is obtained.

In other words, the output of the DC-DC converter 25 is subjected to the dimming start control such that the output of the AC-DC converter 24 can be smoothed by the electrolytic capacitor C3 having low capacitance.

Consequently, the protecting circuit 30a does not function and the LED elements 11 are lit in a fade-in manner.

The temperature of the electrolytic capacitor C3 rises according to energization and the capacitance and the impedance of the electrolytic capacitor C3 are restored to the rated values. Therefore, when the output of the DC-DC converter 25 increases to the rated output according to the dimming start, the LED elements 11 are lit at stable predetermined brightness.

In FIG. 5, a result obtained by performing measurement concerning a relation between the capacitance of the electrolytic capacitor C3 and a dimming output ratio at which lighting is possible is shown. Even in a state in which the capacitance of the electrolytic capacitor C3 decreased to 30% or less, it was able to be confirmed that, at a dimming output ratio equal to or lower than 30%, the protecting circuit 30a did not function and the LED elements 11 were lit. Therefore, in the fade-in lighting, a dimming output ratio at start time when the DC-DC control section 32 performs the dimming start control may be from 30% rather than from 0%.

Therefore, even if the capacitance of the electrolytic capacitor C3 decreases to be lower than the rated value or the impedance of the electrolytic capacitor C3 increases to be higher than the rated value under the low-temperature environment equal to or lower than −20° C., it is possible to surely light the LED elements 11 by performing the fade-in lighting, which is the initial lighting operation. Moreover, it is possible to surely light the LED elements 11 easily by only changing a control program of the control circuit 17 without changing a component of the lighting circuit 16 or adding another component.

If a voltage value or a high-frequency ripple component of a smoothed voltage, which is an output of the AC-DC converter 24, is detected and the voltage value or the high-frequency ripple is equal to or smaller than a fixed value, the fade-in lighting may be performed. Consequently, if the capacitance of the electrolytic capacitor C3 decreases to be lower than the rated value or the impedance of the electrolytic capacitor C3 increases to be higher than the rated value under the low-temperature environment equal to or lower than −20° C., it is possible to surely light the LED elements 11 by performing the fade-in lighting. For example, when the LED elements 11 are lit again immediately after light-out, if the capacitance of the electrolytic capacitor C3 is not reduced to be lower than the rated value or the impedance of the electrolytic capacitor C3 is not increased to be higher than the rated value, it is possible to immediately light the LED elements 11 at the rated output without performing the fade-in lighting. Further, if the voltage value or the high-frequency ripple component of the smoothed voltage, which is the output from the AC-DC converter 24, is equal to or smaller than the fixed value and continues for a predetermined time or more, the control circuit may stop the lighting circuit 16 determining that a deficiency is not caused by a drop of the temperature of the electrolytic capacitor C3 and is caused by another factor. The detecting section 30 used for the control by the control circuit 17 can be used for the detection of the voltage value or the high-frequency ripple component of the smoothed voltage, which is the output from the AC-DC converter 24. Therefore, it is possible to surely light the LED elements 11 easily by only changing a control program of the control circuit 17 without changing a component of the lighting circuit 16 or adding another component.

As the initial lighting operation, resetting of the protecting circuit operation and the lighting operation may be repeated a predetermined number of times. In this case, as explained above, the LED lighting circuit 10 performs the lighting operation at the rated output during the start of energization. Therefore, the output of the AC-DC converter 24 is not normally smoothed by the electrolytic capacitor C3, the protecting circuit 30a functions, and the lighting circuit 16 is stopped according to the protecting circuit operation. However, the control circuit 17 resets the protecting circuit operation and resumes the lighting operation after the protecting circuit operation functions. If the protecting circuit 30a functions again even if the lighting operation is resumed, the protecting circuit operation is performed.

In this way, the resetting of the protecting circuit operation and the lighting operation are repeated according to the control by the control circuit 17 and energization to the electrolytic capacitor C3 is performed during the repetition. Therefore, since the temperature of the electrolytic capacitor C3 rises and the capacitance and the impedance of the electrolytic capacitor C3 are restored to the rated values, the output from the AC-DC converter 24 changes to a smoothed direct-current voltage. Consequently, after the resetting of the protecting circuit operation and the lighting operation are repeated plural times, abnormality is not detected by the protecting circuit 30a, the lighting operation is continued, and the LED elements 11 are lit at the stable predetermined brightness.

Therefore, even if the capacitance of the electrolytic capacitor C3 decreases to be lower than the rated value or the impedance of the electrolytic capacitor C3 increases to be higher than the rated value under the low-temperature environment equal to or lower than −20° C., it is possible to surely light the LED elements 11 by repeating the resetting of the protecting circuit operation and the lighting operation according to the initial lighting operation. Moreover, it is possible to surely light the LED elements 11 easily by only changing the control program of the control circuit 17 without changing a component of the lighting circuit 16 or adding another component.

If the protecting circuit 30a functions even if the resetting of the protecting circuit operation and the lighting operation are repeated to a predetermined upper limit number of times set in advance, the control circuit 17 stops the resetting by the protecting circuit operation determining that a deficiency is not caused by a drop of temperature of the electrolytic capacitor C3 and is caused by another factor and retains a stop state of the lighting circuit 16 by the protecting circuit operation.

The initial lighting operation may be disabling of the protecting circuit operation and enabling of the protecting circuit operation after the elapse of a predetermined time from the start of energization. In this case, since the LED lighting circuit 10 performs the lighting operation at the rated output during the start of energization, the output of the AC-DC converter 24 is not normally smoothed by the electrolytic capacitor C3 and the protecting circuit 30a functions. However, the control circuit 17 disables the protecting circuit operation. Alternatively, the protecting circuit 30a of the control circuit 17 is also disabled to disable the protecting circuit operation.

Since the protecting circuit operation is disabled during the start of energization, the lighting circuit 16 is not stopped and the energization to the electrolytic capacitor C3 is continued. Therefore, since the temperature of the electrolytic capacitor C3 rises and the capacitance and the impedance of the electrolytic capacitor C3 are restored to the rated values, the output from the AC-DC converter 24 changes to a smoothed direct-current output. Consequently, the LED elements 11 are lit at the stable predetermined brightness.

After a predetermined time set in advance sufficient for the capacitance and the impedance of the electrolytic capacitor C3 to be restored to the rated values elapses, the control circuit 17 enables the protecting circuit operation and prepares for abnormal detection after lighting.

Therefore, even if the capacitance of the electrolytic capacitor C3 decreases to be lower than the rated value or the impedance of the electrolytic capacitor C3 increases to be higher than the rated value under the low-temperature environment equal to or lower than −20° C., it is possible to surely light the LED elements 11 by disabling the protecting circuit operation and enabling the protecting circuit operation after the elapse of the predetermined time from the start of energization according to the initial lighting operation. Moreover, it is possible to surely light the LED elements 11 easily by only changing the control program of the control circuit 17 without changing a component of the lighting circuit 16 or adding another component.

As a threshold for the protecting circuit 30a to determine abnormality, plural thresholds including a first threshold for determining abnormality during initial lighting and a second threshold higher than the first threshold may be set. During the initial lighting, determination by a threshold equal to or smaller than the first threshold for determining abnormality during the initial lighting may be disabled and determination by the second threshold larger than the first threshold for determining abnormality during the initial lighting may be kept enabled. In this case, even during the initial lighting, it is possible to detect abnormality due to another factor rather than a deficiency due to a drop of the temperature of the electrolytic capacitor C3 and stop the lighting circuit 16.

If the voltage value or the high-frequency ripple component of the smoothed voltage, which is the output from the AC-DC converter 24, is detected and the voltage value or the high-frequency ripple is equal to or smaller than the fixed value, the protecting circuit operation may be disabled. Consequently, if the capacitance of the electrolytic capacitor C3 decreases to be lower than the rated value or the impedance of the electrolytic capacitor C3 increases to be higher than the rated value under the low-temperature environment equal to or lower than −20° C., it is possible to surely light the LED elements 11 by disabling the protecting circuit operation. For example, when the LED elements 11 are lit again immediately after light-out, if the capacitance of the electrolytic capacitor C3 is not reduced to be lower than the rated value or the impedance of the electrolytic capacitor C3 is not increased to be higher than the rated value, it is possible to light the LED elements 11 without disabling the protecting circuit operation. Further, if the voltage value or the high-frequency ripple component of the smoothed voltage, which is the output from the AC-DC converter 24, exceeds the fixed value, the protecting circuit operation may be enabled irrespective of the elapse of time from the start of energization. If the voltage value or the high-frequency ripple component of the smoothed voltage, which is the output from the AC-DC converter 24, is equal to or smaller than the fixed value and continues for a predetermined time or more, the control circuit 17 may stop the lighting circuit 16 determining that a deficiency is not caused by a drop of the temperature of the electrolytic capacitor C3 and is caused by another factor.

A film capacitor, the capacitance of which is not affected by a drop of temperature, may be connected in parallel to the electrolytic capacitor C3. A part of the capacitance of the electrolytic capacitor C3, the capacitance of which decreases according to a drop of temperature, may be supplemented by the film capacitor to smooth an output voltage from the AC-DC converter 24.

During the initial lighting, a load such as a resistor serving as the impedance may be temporarily connected in parallel to the electrolytic capacitor C3 to feed an electric current to the electrolytic capacitor C3 and raise the temperature of the electrolytic capacitor C3.

While certain embodiments have been described, these embodiments have been presented by way of example only, and are not intended to limit the scope of the inventions. Indeed, the novel embodiments described herein may be embodied in a variety of other forms; furthermore, various omissions, substitutions, and changes in the form of the embodiments described herein may be made without departing from the spirit of the inventions. The accompanying claims and their equivalents are intended to cover such forms or modifications as would fall within the scope and spirit of the inventions.

What is claimed is:

1. An LED lighting circuit comprising:
a lighting circuit provided between an external power supply and LED elements, the lighting circuit including an electrolytic capacitor, capacitance of which decreases to be lower than a rated value or impedance of which increases to be higher than a rated value at temperature equal to or lower than −20° C.; and
a control circuit configured to control the lighting circuit and perform an initial lighting operation under a temperature environment equal to or lower than −20° C.

2. The circuit according to claim 1, wherein the control circuit determines abnormality of an output of the lighting circuit and performs a protecting circuit operation for the lighting circuit.

3. The circuit according to claim 2, wherein the initial lighting operation of the control circuit is fade-in lighting for preventing the protecting circuit operation from functioning.

4. The circuit according to claim 2, wherein the initial lighting operation of the control circuit is a predetermined number of times of repetition of resetting of the protecting circuit operation and a lighting operation.

5. The circuit according to claim 2, wherein the initial lighting operation of the control circuit is disabling of the protecting circuit operation and enabling of the protecting circuit operation after elapse of a predetermined time from start of energization.

6. The circuit according to claim 1, wherein
an electrolyte that freezes at the temperature equal to or lower than −20° C. is encapsulated in the electrolytic capacitor, and
the electrolyte is dissolved by the initial lighting operation of the control circuit.

7. The circuit according to claim 1, wherein the control circuit has a plurality of thresholds including a first threshold for determining abnormality during initial lighting and a second threshold higher than the first threshold and, during the initial lighting operation, disables determination by a threshold equal to or smaller than the first threshold and enables determination by the second threshold.

8. An LED luminaire comprising:
an LED element; and
an LED lighting circuit including:
a lighting circuit provided between an external power supply and LED elements, the lighting circuit including an electrolytic capacitor, capacitance of which decreases to be lower than a rated value or impedance of which increases to be higher than a rated value at temperature equal to or lower than −20° C.; and
a control circuit configured to control the lighting circuit and perform an initial lighting operation under a temperature environment equal to or lower than −20° C.

9. The luminaire according to claim 8, wherein the control circuit determines abnormality of an output of the lighting circuit and performs a protecting circuit operation for the lighting circuit.

10. The luminaire according to claim 9, wherein the initial lighting operation of the control circuit is fade-in lighting for preventing the protecting circuit operation from functioning.

11. The luminaire according to claim 9, wherein the initial lighting operation of the control circuit is a predetermined number of times of repetition of resetting of the protecting circuit operation and a lighting operation.

12. The luminaire according to claim 9, wherein the initial lighting operation of the control circuit is disabling of the protecting circuit operation and enabling of the protecting circuit operation after elapse of a predetermined time from start of energization.

13. The luminaire according to claim 9, wherein
an electrolyte that freezes at the temperature equal to or lower than −20° C. is encapsulated in the electrolytic capacitor, and
the electrolyte is dissolved by the initial lighting operation of the control circuit.

14. The luminaire according to claim 9, wherein the control circuit has a plurality of thresholds including a first threshold for determining abnormality during initial lighting and a second threshold higher than the first threshold and, during the initial lighting operation, disables determination by a threshold equal to or smaller than the first threshold and enables determination by the second threshold.
